(19) United States
(12) Patent Application Publication
(10) Pub. No.: US 2013/0314909 A1
(43) Pub. Date: Nov. 28, 2013

(54) SELF-LUMINOUS AND REFLECTIVE PAVEMENT MARKER

(71) Applicant: Hung-Chen Lee, Taipei City (TW)

(72) Inventor: Hung-Chen Lee, Taipei City (TW)

(21) Appl. No.: 13/481,875

(22) Filed: May 28, 2012

(51) Int. Cl. F21L 4/02; F21V 7/00

(52) U.S. Cl. 362/183

(57) ABSTRACT

A pavement marker which can passively reflect incident rays and independently emit light is disclosed. It includes a housing and a unidirectionally reflective/light-penetrative panel (URLPP) covering the housing to form an inner space and having a central hole. A rechargeable battery, a circuit board with LEDs and a generator are received in the inner space. The circuit board and generator electrically connect to the rechargeable battery. The generator has a spindle penetrating the central hole. The propeller is fixed to the spindle. The generator and the propeller constitute a wind generator to charge the rechargeable, outer light projected onto the URLPP will be reflected, and beams emitted by the LEDs will penetrate through the URLPP.

### BACKGROUND OF THE INVENTION

1. Technical Field

The invention relates to pavement markers, particularly to reflective and luminous pavement markers.

2. Related Art

FIGS. 1-3 depict a conventional reflective pavement marker. In such a marker, a shaft 42 is pivoted at the center of a reflective side 30 of a round reflector 3. A bearing 302 and a hub 43 are put around the shaft 42. Three blades 40 are fastened to the hub 43 by screws 402 to form a propeller 4. Each blade 40 is attached with a brush 400 in contact with the reflective side 30. When the propeller 4 is blown to rotate by wind, the brushes 400 can brush away dust and dirt on the reflective side 30.

Although such a pavement marker is relatively great, it is a purely passive marker which only can reflect incident light and cannot emit light to serve as a luminous marker. Currently luminous markers need external electric power. This means power lines must be buried under the roads on which the luminous markers are installed. Obviously, this must destroy roads and will cost a lot.

### SUMMARY OF THE INVENTION

An object of the invention is to provide a pavement marker, which can both reflect incident light and independently emit light.

To accomplish the above object, the pavement marker of the invention includes a housing and a unidirectionally reflective/light-penetrative panel (URLPP) covering the housing to form an inner space and having a central hole. A rechargeable battery, a circuit board with LEDs and a generator are received in the inner space. The circuit board and generator electrically connect to the rechargeable battery. The generator has a spindle penetrating the central hole. The propeller is fixed to the spindle. The generator and the propeller constitute a wind generator to charge the rechargeable, outer lights projected onto the URLPP will be reflected, and beams emitted by the LEDs will penetrate through the URLPP.

### BRIEF DESCRIPTION OF THE DRAWINGS

FIG. 1 is an exploded view of a conventional auto-clean reflective pavement marker;

FIG. 2 is an assembled view of the marker of FIG. 1;

FIG. 3 is a cross-sectional view of the marker of FIG. 1;

FIG. 4 is an exploded view of the invention;

FIG. 5 is an assembled view of the invention;

FIG. 6 is a schematic view of the battery cover of the invention; and

FIG. 7 is a schematic view of the invention.

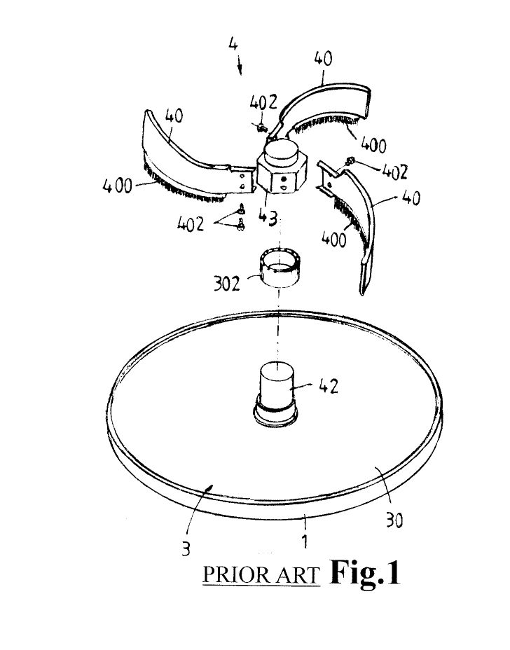

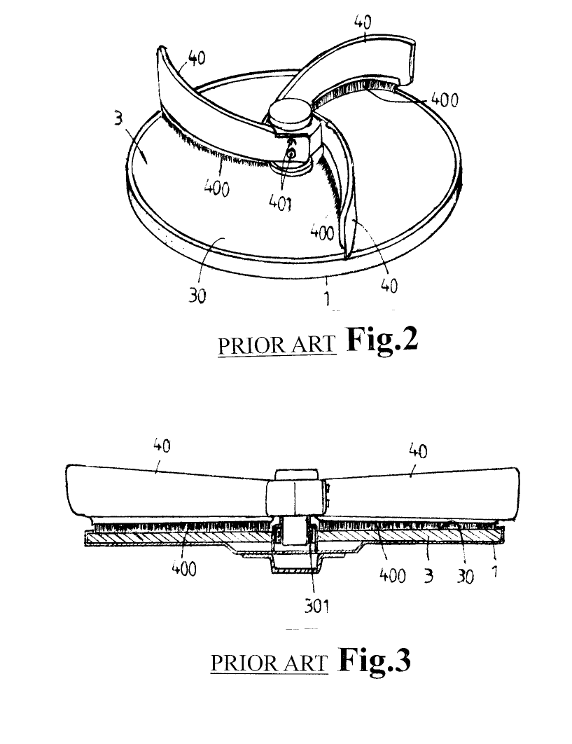

### DETAILED DESCRIPTION OF THE INVENTION

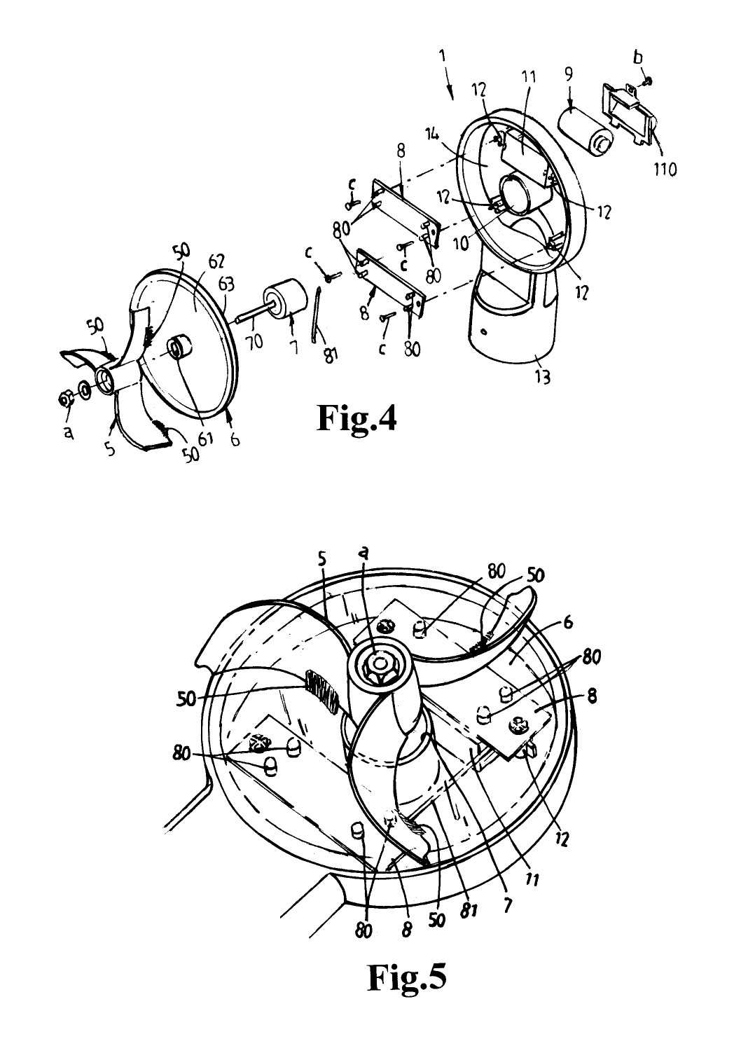

Please refer to FIGS. 4-5. The invention includes a housing 1, a propeller 5, a unidirectionally reflective/light-penetrative panel (URLPP) 6, a generator 7, a circuit board 8 and a rechargeable battery 9. The housing 1 is composed of a round portion and a base portion 13. The round portion is formed with a generator room 10 at the center thereof for receiving the generator 7, a battery room 11 for receiving the rechargeable battery 9 and four posts 12 for supporting the circuit board 8. The generator 7, the rechargeable battery 9 and the circuit board 8 are electrically connected therewith.

The URLPP 6 is of a round shape and covers the round portion of the housing 1 to form an inner space 14. The URLPP 6 is provided with a reflective side 62 which can reflect incident light from the outside and a light-penetrative side 63 which permits light from the inside to penetrate through. The reflective side 62 faces outwards so it can reflect light from the outside. Further, the URLPP 6 has a central hole 61.

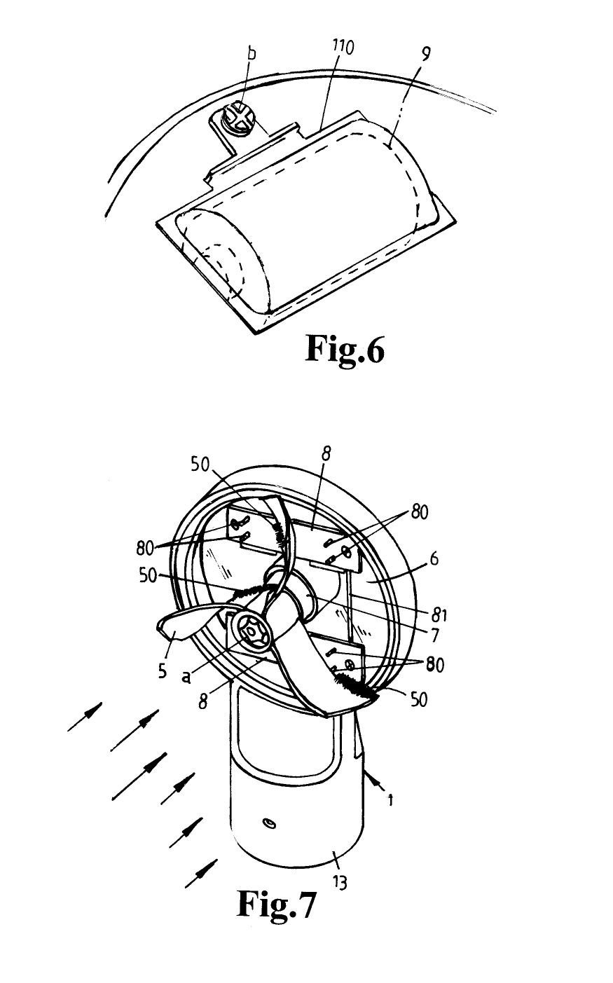

The generator 7 has a spindle 70 penetrating the central hole 61 and is electrically connected to the rechargeable battery 9 for charging it. The propeller 5 is fixed to the spindle 70 with a nut (a) and has a plurality of blades. The battery room 11 is provided with cover 110 which is fastened by a screw (b) as shown in FIG. 6. A plurality of light emitting diodes (LEDs) 80 are mounted on the circuit board 8. The circuit board 8 is fixed on the posts by screws (c). The circuit board 8 is electrically connected to the rechargeable battery 9 for being powered. Thus the LEDs 80 can light up without external power when needed.

The base 13 of the housing 1 is used for being mounted on a road. The generator 7 and the propeller 5 constitute a wind generator. The generator 7 charges the rechargeable battery 9 when the propeller 5 is blown by wind. Outer light projected onto the URLPP 6 will be reflected, and beams emitted by the LEDs 80 will penetrate through the URLPP 6 as shown in FIG. 7. In other words, the pavement marker of the invention has two functions: a reflective marker and a luminous marker. And the LEDs 80 can independently light up without external power.

In the shown embodiment, the circuit board 8 is composed of two separate pieces which are electrically connected by a wire 81.

Each blade of the propeller 5 is provided with a brush 50. These brushes 50 are in contact with the reflective side 62 of the URLPP 6, so they can brush away dust and dirt on the USLPP 6 when the propeller 5 is rotating. Preferably, length of each the brush 50 is shorter than that of each the blade to reduce friction.

Preferably, the propeller 5 is made of a transparent material for allowing the light from the LEDs 80 to penetrate through.

It will be appreciated by persons skilled in the art that the above embodiment has been described by way of example only and not in any limitative sense, and that various alterations and modifications are possible without departure from the scope of the invention as defined by the appended claims. It will be appreciated by persons skilled in the art that the above embodiment has been described by way of example only and not in any limitative sense, and that various alterations and modifications are possible without departure from the scope of the invention as defined by the appended claims.

What is claimed is:

1. A pavement marker comprising:
a housing;
a unidirectionally reflective/light-penetrative panel (URLPP) with a reflective side and a light-penetrative side, covering the housing to form an inner space, and having a central hole, wherein the reflective side faces outwards;
a rechargeable battery, received in the inner space;
a circuit board with light emitting diodes (LEDs), fixed in the inner space, and electrically connected to the rechargeable battery;
a generator, fixed in the inner space, having a spindle penetrating the central hole, and electrically connected to the rechargeable battery; and
a propeller, fixed to the spindle, and having blades;
wherein the generator and the propeller constitute a wind generator to charge the rechargeable battery, outer light projected onto the URLPP will be reflected, and beams emitted by the LEDs will penetrate through the URLPP.

2. The pavement marker of claim 1, wherein each the blade is attached with a brush in contact with the reflective side of the URLPP.

3. The pavement marker of claim 1, wherein the propeller is made of a transparent material.
